(19) United States
(12) Patent Application Publication
(10) Pub. No.: US 2015/0174541 A1
(43) Pub. Date: Jun. 25, 2015

(54) DEVICE FOR APPLYING A PASTY MASS

(71) Applicant: SCA Schucker GmbH & Co. KG, Bretten (DE)

(72) Inventors: Bernd Koelle, Oberderdingen (DE); Patrick Scholl, Ellhofen (DE)

(73) Assignee: SCA Schucker GmbH & Co. KG, Bretten (DE)

(21) Appl. No.: 14/409,069

(22) PCT Filed: May 15, 2013
(86) PCT No.: PCT/EP2013/060007

§ 371 Date: Dec. 18, 2014

(30) Foreign Application Priority Data
Jun. 22, 2012 (DE) 10 2012 012 360.4

(51) Int. Cl. B01F 15/02

(52) U.S. Cl. CPC B01F 15/0202

(57) ABSTRACT

A device for applying a pasty mass having an at least two-component, curable adhesive or sealant includes a housing, a lance, which is accommodated in the housing and can be rotated about a longitudinal housing axis and in the interior of which a material supply channel extends to a lance tip bounding the lance in the axial direction for each component of the adhesive or sealant, and a rotary feed-through for introducing the component of the adhesive or sealant into the respective material supply channel through a jacket of the housing, wherein a closing valve is associated with each material supply channel, which closing valve can close the material supply channel at a valve seat.

The invention relates to an apparatus for application of a paste-type compound having at least one two-component, curable adhesive or sealant.

Known apparatuses of this type are used, for example, for application of two-component adhesives to work pieces. They have what is called a lance, an elongated body in which a material feed channel runs for each of the components, which channel is connected with a feed line for the component by way of a connector, and can be shut off by means of a valve that acts on a valve seat. The material feed channels run all the way to a lance tip and empty into one or more exit openings there. A mixing device can be connected at the lance tip, in which device the components are mixed with one another, or mixing already takes place in the lance, so that an application nozzle can be directly connected to the lance tip, with which nozzle the paste-like compound can be applied to a work piece. It is a disadvantage of the known apparatuses that the lance cannot be rotated about its longitudinal axis, because otherwise the feed lines could become wound around the lance. However, rotatability of the lance is desirable for some areas of application, for example if the lance is disposed on a robot, particularly if the application nozzle is curved.

The invention is therefore based on the task of creating an apparatus of the type stated initially, which can be used more flexibly.

This task is accomplished, according to the invention, by means of an apparatus having the characteristics of claim 1. Advantageous further developments of the invention are the object of the dependent claims.

The invention is based on the idea of introducing the components into the respective material feed channel by means of a rotary feed-through, so that the lance can be rotatably accommodated in a housing. When the lance rotates about the longitudinal housing axis, the housing can remain fixed in place, so that the lines connected to the housing are not also rotated. Furthermore, a mixing device for mixing the components, with the formation of the adhesive or sealant, can be attached to the lance tip, into which device the material feed channels empty.

Furthermore, an application nozzle having an application opening for application of the paste-type compound to a work piece can be attached to the lance tip or to a side of the mixing device facing away from the lance. The application device has a material application channel that runs from the mixing device or from the lance tip all the way to the application opening, for transport of the paste-type compound from the mixing device or from the lance tip to the application opening, which channel has at least one curved section and therefore is not rotation-symmetrical with regard to the longitudinal housing axis. Such application nozzles are particularly used where application of the paste-type compound is supposed to take place transverse to the longitudinal housing axis or parallel to the longitudinal housing axis, in the direction back toward the lance tip, for example if the application nozzle is supposed to engage around a work piece and coat it with the paste-type compound from behind.

It is practical if the closing valves have a piston, in each instance, which is accommodated in a cylinder disposed in the housing so as to be linearly displaceable and to which a pressure medium can be applied, whereby a further rotary feed-through is provided for introduction of a pressure medium through the jacket of the housing into the respective cylinder.

In this way, the fact that predominantly pressure-activated needle valves are used as closing valves in such application apparatuses is taken into account, whereby the introduction of the pressure medium is also supposed to take place in the same manner as the introduction of the components of the adhesive or sealant, so that the feed lines of the pressure medium also cannot become wound around the lance when the latter rotates.

According to a preferred embodiment, each material feed channel empties into an exit opening at the lance tip. It is practical if the exit openings are disposed at a reciprocal distance of maximally 30 mm, preferably of maximally 20 mm, from one another, so that conventional static mixers can be attached to the lance tip. Preferably, the material feed channels run toward one another, at least in certain sections, in the direction toward the lance tip, whereby it is advantageous if the sections of the material feed channels that run toward one another are disposed between the valve seats of the closing valves and the lance tip. As a result, the exit openings can be disposed close to one another, while the valve seats can have a greater distance from one another, so that there is sufficient room in the lance for the valves. This is advantageous because the needle valves should be disposed to run parallel to the longitudinal housing axis, if possible, in order to keep the width of the lance as small as possible.

According to an alternative advantageous embodiment, the material feed channels each empty into an end channel that empties into an exit opening at the lance tip. In the end channel, the first mixing of the components can already take place. It is practical if the material feed channels empty into the end channel at different distances from the exit opening, measured in a longitudinal direction of the end channel that extends toward the exit opening. The material streams of the components then combine in the end channel, in that one material stream empties into the other. In this connection, it is preferred that the cross-section of the end channel increases in size toward the exit opening, corresponding to the increase in the material flowing in the end channel toward the exit opening. In particular, the cross-section of the end channel can increase in size at every location at which a material feed channel empties into it, so that the material feed channel is completely filled with material, or filled to the greatest possible extent, at every location all the way to the exit opening. It is advantageous if the end channel is disposed in a bottom of the lance, at the lance tip, and covered by a cover plate that has the valve seats.

According to an advantageous further development, a further feed channel for a flushing medium, running in the interior of the lance is provided, which channel runs to the lance tip, and a rotary feed-through intended for introduction of the flushing medium into the further feed channel is provided. After the end of an application procedure, the apparatus can be flushed with the flushing medium, so that residues of the curable adhesive or sealant are removed from it, to the greatest possible extent. In the embodiment in which the material feed channels empty into an end channel, it is advantageous if the further feed channel empties into the end channel farther away from the exit opening than the material feed channels, in order to be able to flush residues of the components out of the end channel.

In the following, the invention will be described in greater detail using an exemplary embodiment shown schematically in the drawing. This shows:

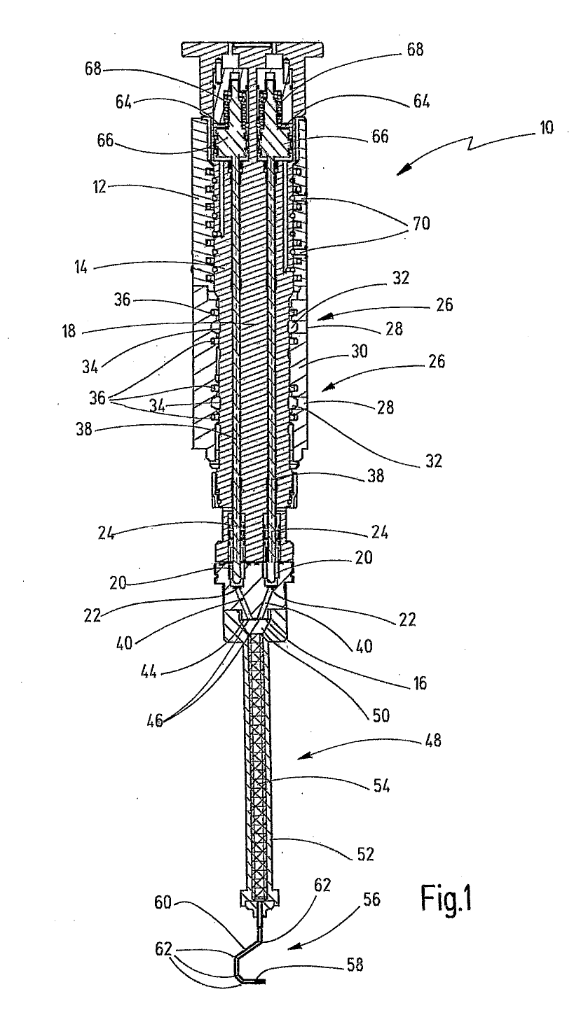

FIG. 1 an application apparatus in longitudinal section, and

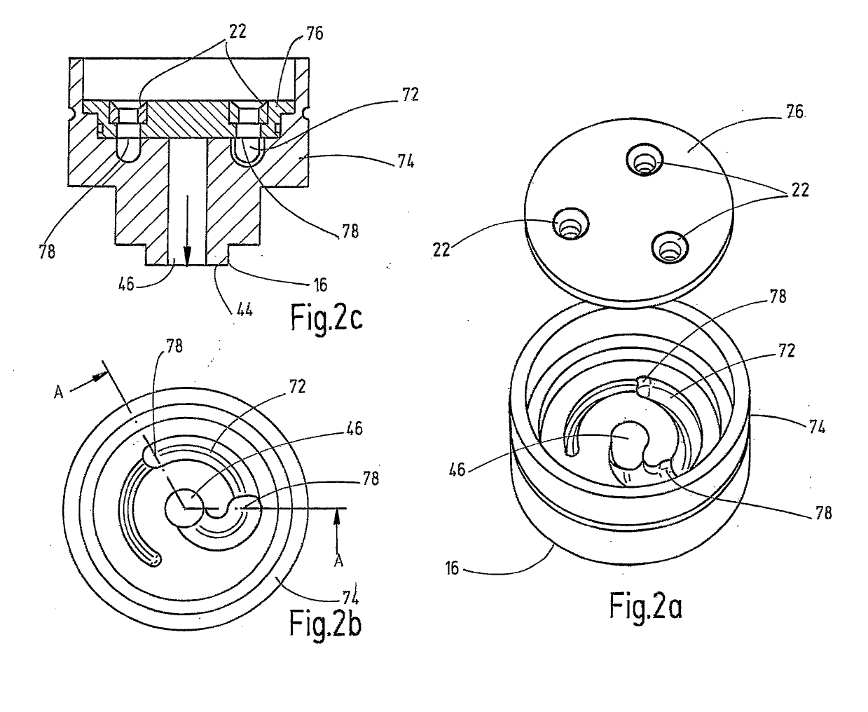

FIG. 2a to c, an alternative embodiment of the lance tip in a perspective representation, with the cover plate removed, in a top view without cover plate and in section along the line A-A with cover plate.

The application apparatus 10 for two-component, curable adhesives, shown in FIG. 1, has a housing 12 and an application lance 14 accommodated in the housing 12, which lance can be rotated about a longitudinal axis of the housing 12, which lance projects out of the housing 12 with its tip 16. Two material feed channels 20 run parallel to the longitudinal housing axis in the direction toward the lance tip 16, in a body 18 of the lance 14. The material feed channels 20 can each be closed off on a valve seat 22, by means of a needle valve 24. The introduction of the two components into the related material feed channel 20 takes place by means of a rotary feed-through 26: For each component, a bore 28 is provided in the housing jacket 30, which bore empties into a ring groove 32 that runs circumferentially on the housing 12. A further ring groove 34, which runs circumferentially around the outside of the lance body 18, lies opposite the ring groove 32 in the housing 12, in each instance. A radial bore that leads to one of the material feed channels 20, in each instance, not shown in the drawing, then empties into the ring groove 34 on the lance body 18, so that a component can be introduced into one of the material feed channels 20 by way of each ring groove pair 32, 34. It is understood that the combination of the ring grooves 32, 34 should be understood merely as an example. It is also possible that a ring groove 32 is disposed only in the housing 12, while the lance body 18 has a cylindrical jacket surface in this region. Likewise, it is possible that a ring groove 34 is disposed only in the lance body 18, while the housing 12 has an inner surface in the form of a cylinder jacket at this location. The ring groove pairs 32, 34 are sealed off by means of circumferential seals 36, in each instance, in the exemplary embodiment shown.

While the material feed channels 20 run parallel to one another and parallel to the longitudinal housing axis over the major portion of their length, and the needles 38 of the needle valves 24 are accommodated in them so as to be longitudinally displaceable, the sections 40 of the material feed channels 20 that extend between the valve seats 22 and the lance tip 16 run toward one another up to an exit opening 46 disposed in a face surface 44 of the lance tip 16, in each instance. A static mixer 48 is releasably attached to the lance tip 16, which mixer has a funnel 50 at its end facing the lance 14, into which funnel the exit openings 46 empty. Following the funnel 50, the mixer 48 has a plastic pipe 52, in which a mixing spiral 54 is disposed.

An application nozzle 56 is releasably attached to the end of the mixer 48 facing away from the lance 14, which nozzle has a material application channel 60 that runs from the mixer 48 all the way to an application opening 58. This channel does not run straight, but rather has multiple curved sections 62, so that the application nozzle 56 has the shape of a hook and applies the adhesive exiting from the mixer 48 back in the direction of the lance 14. Such a hook-shaped application nozzle 46 is particularly used to engage behind a work piece at its edge and to apply an adhesive layer to its back side.

Opening of the needle valves 24 by means of lifting the needles 38 off from the valve seats 22 takes place, in each instance, by means of applying pressure, counter to the force of a reset spring 68, to a piston 66 firmly connected with the respective needle 38, which piston is guided in a cylinder 64 that is accommodated in the housing 12 and firmly connected with the lance 14. For applying pressure to the respective piston 66, a pressure medium is introduced into the respective cylinder 64 by way of a further rotary feed-through 70, whereby the further rotary feed-through 70 is structured according to the principle of the rotary feed-through 26. Contrary to the exemplary embodiment shown, a dual-action cylinder can also be used, in each instance.

According to a second exemplary embodiment, a third feed channel is also provided in the lance 14, which channel serves for introduction of a flushing medium. The flushing medium, like the two adhesive components, is also introduced into the feed channel by way of a rotary feed-through. Different from the first exemplary embodiment, only one exit opening 46 is disposed in the lace tip 16, which opening empties into an end channel 72 in the bottom 74 of the lance 14. The end channel 72 is covered by a cover plate 76, in which the valve seats 22 are situated. The material feed channels 20 empty into the end channel 72 at outlet openings 78, which are disposed at different distances from the exit opening 46 in a longitudinal direction of the end channel 72 that extends toward the exit opening 46. At every outlet opening 78, the cross-section of the end channel 72 widens, in order to be able to accommodate the newly added amount of material. The feed channel for the flushing medium empties into the end channel 72 below the related valve seat 22, at the end of the channel facing away from the exit opening 46, so that the end channel 72 can be flushed over its entire length that accommodates the adhesive components, by means of introduction of the flushing medium into the channel.

In summary, the following should be stated: The invention relates to an apparatus 10 for application of a paste-type compound having at least one two-component, curable adhesive or sealant, the apparatus having a housing 12, a lance 14 accommodated in the housing 12, which lance can rotate about a longitudinal housing axis, in the interior of which lance a material feed channel 20 for each component of the adhesive or sealant runs to a lance tip 16 that delimits the lance 14 in the axial direction, and having a rotary feed-through 26 for introduction of the components of the adhesive or sealant through a jacket 30 of the housing 12 into the respective material feed channel 20, wherein a closing valve 24 is assigned to each material feed channel 20, by means of which valve the material feed channel 20 can be closed off at a valve seat 22.

### REFERENCE SYMBOL LIST

10 application apparatus

12 housing

14 application lance

16 lance tip

18 body

20 material feed channels

22 valve seat

24 needle valve

26 rotary feed-through

28 bore

30 housing jacket

32, 34 ring groove

36 seal

38 needle

40 converging sections

44 face surface

46 exit opening

48 mixer

50 funnel

52 plastic pipe

54 mixing spiral

56 application nozzle

58 application opening

60 material application channel

62 curved sections

64 cylinder

66 piston

68 reset spring

70 further rotary feed-through

72 end channel

74 bottom

76 cover plate

78 outlet opening

1. Apparatus for application of a paste-type compound having at least one two-component, curable adhesive or sealant, the apparatus having a housing (12), a lance (14) accommodated in the housing (12), which lance can rotate about a longitudinal housing axis, in the interior of which lance a material feed channel (20) for each component of the adhesive or sealant runs to a lance tip (16) that delimits the lance (14) in the axial direction, and having a rotary feed-through (26) for introduction of the components of the adhesive or sealant through a jacket (30) of the housing (12) into the respective material feed channel (20), wherein a closing valve (24) is assigned to each material feed channel (20), by means of which valve the material feed channel (20) can be closed off at a valve seat (22).

2. Apparatus according to claim 1, comprising a mixing device (48) releasably attached to the lance (14), for mixing the components, with the formation of the adhesive or sealant, into which device the material feed channels (20) empty at the lance tip (16).

3. Apparatus according to claim 1, comprising an application nozzle (56) disposed on a side of the mixing device (48) facing away from the lance (14) or at the lance tip (16), which nozzle has an application opening (58) for application of the paste-type compound to a work piece and a material application channel (60) that runs from the mixing device (48) or from the lance tip (16) all the way to the application opening (58), and has at least one curved section (62), for transport of the paste-type compound from the mixing device (48) or from the lance tip (16) to the application opening (58).

4. Apparatus according to claim 1, wherein the closing valves (24) each have a piston (66) that is linearly displaceable in a cylinder (64) disposed in the housing (12), to which piston a pressure medium can be applied, and wherein a further rotary feed-through (70) for introduction of the pressure medium through the jacket (30) of the housing (12) into the respective cylinder (64) is provided.

5. Apparatus according to claim 1, wherein each material feed channel (20) empties into an exit opening (46) at the lance tip (16).

6. Apparatus according to claim 5, wherein the exit openings (46) are disposed at a reciprocal distance of maximally 30 mm, preferably of maximally 20 mm, from one another.

7. Apparatus according to claim 5, wherein the material feed channels (20) run toward one another, at least in certain sections, in the direction toward the lance tip (16).

8. Apparatus according to claim 7, wherein the sections (40) of the material feed channels (20) that run toward one another are disposed between the valve seats (22) of the closing valves (24) and the lance tip (16).

9. Apparatus according to claim 1, wherein the material feed channels (20) each empty into an end channel (72) that empties into an exit opening (46) at the lance tip (16).

10. Apparatus according to claim 9, wherein the material feed channels (20) empty into the end channel (72) at different distances from the exit opening (46), measured in a longitudinal direction of the end channel (72) that extends toward the exit opening (46).

11. Apparatus according to claim 10, wherein the cross-section of the end channel (72) increases in size toward the exit opening (46).

12. Apparatus according to claim 11, wherein the cross-section of the end channel (72) increases in size at every location (78) at which a material feed channel (20) empties into it.

13. Apparatus according to claim 9, wherein the end channel (72) is disposed in a bottom (74) of the lance (14), at the lance tip (16), and is covered by a cover plate (76) that has the valve seats (22).

14. Apparatus according to claim 1, comprising a further feed channel for a flushing medium, running in the interior of the lance (14), which channel runs toward the lance tip (16), and a rotary feed-through intended for introduction of the flushing medium into the further feed channel.

15. Apparatus according to claim 14, wherein the further feed channel empties into the end channel (72) farther away from the exit opening (46) than the material feed channels (20).
